(19) United States
(12) Patent Application Publication
(10) Pub. No.: US 2004/0134590 A1
(43) Pub. Date: Jul. 15, 2004

(54) Process and apparatus for subjecting workpieces having annular shape to machining of their inner and outer surfaces

(76) Inventor: Marcus Caldana, Bologna (IT)

Correspondence Address: STITES & HARBISON PLLC, 1199 NORTH FAIRFAX STREET, SUITE 900, ALEXANDRIA, VA, 22314, US

(21) Appl. No.: 10/475,724

(22) PCT Filed: Jan. 3, 2003
(86) PCT No.: PCT/EP03/00030

(51) Int. Cl. B32B 31/00

(52) U.S. Cl. 156/154; 451/397

(57) ABSTRACT

The annular workpiece (P) to be machined is positioned by one of its bases and with axial alignment onto a cylindrical base structure (1) onto which the workpiece remains secured due to the presence of a suitable adhesive (2) which for example has been previously distributed onto the said base structure. After the setting of the adhesive, the workpiece to be machined is loaded onto the machine tool, so as to be clamped by the chuck of this latter through the base structure (1) which carries it, and no more directly as in the known art. The clamping forces of the chuck are thus discharged onto the base structure (1) and they do not deform at all the workpiece (P) which can be machined with high precision and quickly, both on its inner and outer surfaces and, if required, also on its free base. Upon completion of the machining operation, the workpiece is unloaded from the machine tool and is separated by the base structure by means of a simple and quick mechanical or chemical-physical operation, which neutralizes the action of the adhesive employed.

### TEXT OF THE DESCRIPTION

The operation of positioning and securing onto the chuck of machine tools of workpieces having an annular shape to be subjected to finishing operations presently gives origin to remarkable technical and economical problems, whenever same cannot be clamped in radial direction, because they could be deformed and because they could be damaged on their inner or outer surface which was previously machined and then subjected to the action of the clamping means.

In order to ensure the precise and quick machining onto the inner diameter and/or onto the outer one, with a single positioning onto the chuck of a machine tool, there are known the Italian patent applications BO 2001 A 190 and BO 2001 A 307 belonging to the same applicant (as in the present application) which provide for the disposition onto one of the slides of the machine tool, of automatic positioning devices, which clamp the workpiece to be machined onto the chuck of the machine with an axial clamping, by leaving the workpiece to be machine alternately free on its inner surface or on its outer surface to be subjected to machining operations. These solutions require the cyclical and automatic substitution of the workpiece clamping devices, so that they introduce dead times during the working cycle of the workpiece itself. The positioning of the clamping devices must be moreover carried out with utmost precision and with repeated checks by the machine, these conditions being not acceptable for high working speeds. The present invention intends to further simplify and speed up the positioning onto the chuck of a machine tool of pieces having an annular shape, to be machined both on their inner and outer diameter, by adopting the following idea of solution.

The annular workpiece is positioned frontally by one of its bases and is perfectly centered onto a base structure onto which the workpiece remains secured due to the presence of a suitable adhesive which for example has been previously distributed onto the said base structure. After the setting of the adhesive, the workpiece to be machined is loaded onto the machine tool, in such a manner to be clamped by the chuck through the base structure which holds it, and not directly as in the known art. The clamping forces of the chuck are discharged in this manner onto the base structure and do not at all deform the workpiece which can be then machined with extreme precision and in a quick manner both on its inner and outer surface and, if required, also on its free front. When the machining has been completed, the workpiece is unloaded from the machine tool and is separated from the base structure by means of an easy and quick mechanical or chemical-physical operation which neutralizes the action of the adhesive employed.

The use of an adhesive to secure workpieces is known, for example, from documents U.S. Pat. No. 5,711,835 and JP 61226203 which however do not teach how to secure workpieces having annular shape for the precision machining of their inner and outer surfaces, with a single positioning onto the chuck of machine tools

Further features of the invention, and the advantages deriving therefrom, will appear better evident form the following description of a preferred embodiment of same, illustrated by way of non limiting example in the Figures of the annexed sheets of drawings, in which:

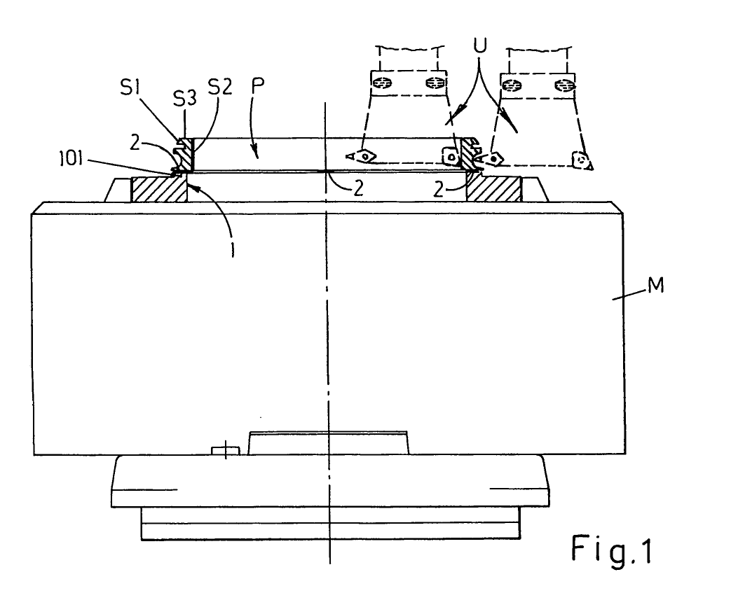

FIG. 1 shows laterally and with parts in section a workpiece secured by employing an adhesive onto the temporary base structure and during the machining phase of the machine tool;

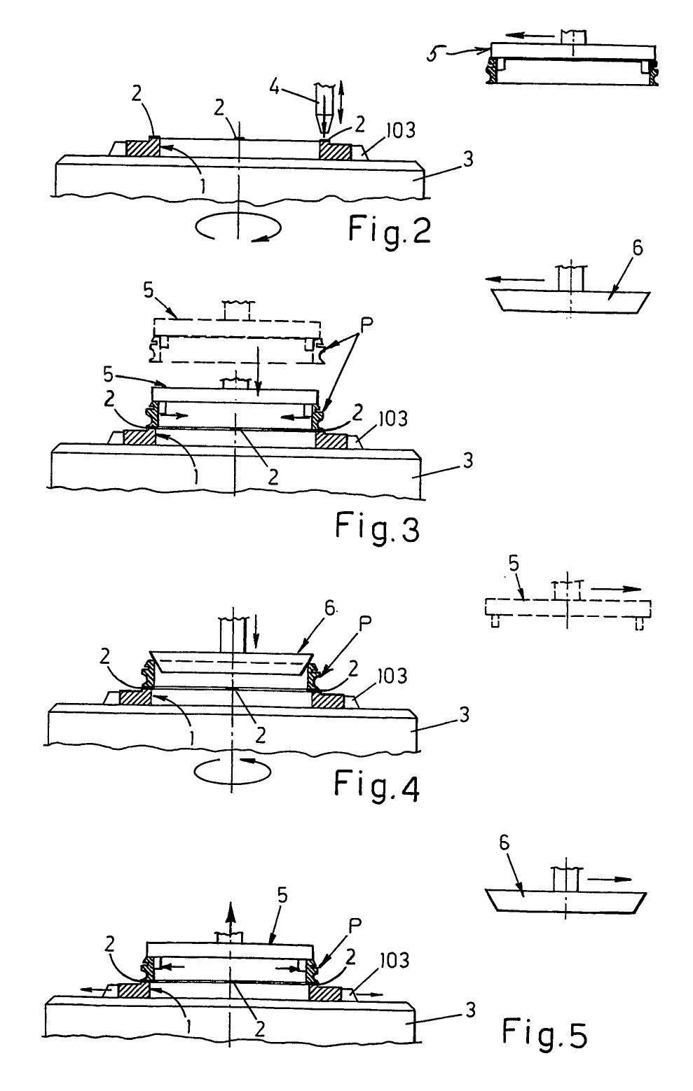

FIGS. 2, 3, 4 and 5 show laterally and with parts in section as many steps of the automatic working cycle for the co-axial securing of a workpiece onto a temporary support base structure, by employing and adhesive.

In FIG. 1, reference letter P indicates the annular workpiece which must be precision machined both on its annular outer surface and on its annular inner surface and which for this purpose rests by its greater base, in a perfect condition of co-axiality onto the annular projection 101 of a strong cylindrical base structure 1, made of any suitable material, for example having as well an annular or other suitable shape. The workpiece P is secured onto the base structure 1 by means of spots suitably distributed on the projection 101, of any suitable quick setting adhesive, for example the adhesive commercially known by the registered trademark LOCTITE of grade 380 or of grade 480.

After the setting of the adhesive, the piece can be automatically loaded onto the chuck M of the machine tool and can be clamped in place by the jaws or by other suitable means which now act on the base structure 1, so that they do not minimally deform the workpiece P which can be machined with precision and in a quick manner by the tools U of a single machine, with tolerances up to the order of three microns, both on the outer surface S1 and on the inner surface S2 and, if required, also on the front surface S3.

After the machining on the machine tool, it will be possible to detach the workpiece from the base structure 1 with a mechanical action which breaks the lattice of the adhesive, if same is of the 380 grade type. For this purpose, it is not excluded that the base structure 1 may be provided with apertures and/or holes which permit to suitable extractors to operate onto the base of the workpiece secured to the base structure. If instead the adhesive is of the 480 grade type, same is neutralized by means of a physical heating action, for example an induction action, at the temperature of about 150°, for a time period of about 20 seconds. It is to be understood that other solutions can be employed for the neutralization of the adhesive.

Referring to FIGS. 2 to 5 there is now described the sequence of working steps of a possible apparatus for securing the workpieces onto the relative supporting base structures. In FIG. 2, reference numeral 3 indicates a vertical axis collet or chuck onto which a manipulator has previously positioned the base structure 1 which is clamped for example from the exterior and co-axially by the jaws 103 of the chuck itself. The chuck together with the base structure 1 is carried into rotation about its axis, while a manipulator with a distributor 4 provides for the distribution onto the projection 101 of the base structure 1 of the adhesive spots 2. The workpiece P to be machined is taken by a gripper manipulator 5 and is positioned onto the projection 101 of the base structure 1, already provided with adhesive spots 2. During this step the chuck 3 is for example at standstill or it is stopped. Subsequently the gripper 5 leaves the workpiece and onto this latter there is moved and axially lowered an idle tailstock center 6, as shown in FIG. 5, which has the double function of pressing the workpiece onto the base structure and to precision align same axially with respect to said base structure. During this step the chuck 3 rotates for the time which is necessary for the setting of the adhesive. Subsequently, as shown in FIG. 5, the chuck 3 is stopped and the tailstock center 6 leaves the workpiece P which is clamped by the gripper 5 or another gripper and is moved away from the chuck, the jaws of which leave free the base structure 1.

1) A process for subjecting workpieces having annular shape to precision machining of their inner and outer surfaces, with a single positioning onto the chuck of machine tools, characterized by the fact that the workpiece is positioned by one of its bases and is axially aligned onto a strong supporting base structure (1) having for example a cylindrical shape, onto which the workpiece is secured by means of a suitable adhesive (2) the whole in such a manner that the said workpiece can be subsequently positioned onto the chuck of the machine tool by clamping the said base structure (1) while the workpiece itself can be machined onto its inner and/or outer surfaces by effecting a single positioning and with high precision, there being provided that after its machining the workpiece be detached from the base structure by means of the neutralization of the adhesion action of the adhesive which will be selected with features such as to be neutralized with quick and easy mechanical an/or chemical and/or physical actions which do not damage the workpiece which has been machined.

2) A process according to claim 1, in which the adhesive is distributed by spots (2) suitably located along the surface of the base structure (1) which supports the workpiece to be machined.

3) A process according to claim 2, in which the spots of adhesives (2) are distributed along the surface of the structure base which is directed upwardly, which is horizontally arranged and which is controlled to rotate about a vertical axis.

4) A process according to claim 2, in which the upwardly directed surface of the base structure (1) provided with the adhesive spots (2,) is positioned co-axially with respect to the workpiece (P) to be secured, which latter is axially aligned and is pressed downwardly for the time required for the setting of the adhesive, after which the assembly consisting of the base structure and of the workpiece can be transferred to the working cycle of the said workpiece onto the machine tool.

5) A process according to claim 1, in which the base structure (1) presents a cylindrical and annular shape.

6) A process according to claim 1, in which the base structure (1) is co-axially provided with an annular projection (101) or with an equivalent projecting portion, onto which there can rest one base of the workpiece (P) to be machined, which therefore is suitably spaced from the said base structure, for the purpose of favouring the correct machining by the tools also of the parts of the workpiece which are near to the supporting base structure.

7) A process according to claim 1, in which the employed adhesive is for example of the type known by the registered trade mark LOCTITE, for example of grade 380.

8) A process according to claim 1, in which the employed adhesive is for example of the type known by the registered trade mark LOCTITE, for example of grade 480.

9) A process according to claim 7, in which the adhesive can be neutralized by means of a mechanical action exerted onto the workpiece and/or onto the base structure supporting same.

10) A process according to claim 8, in which the adhesive can be neutralized by means of a heating operation at a correct value of temperature.

11) Apparatus for subjecting workpieces having annular shape to precision machining of their inner and/or outer surfaces, with a single positioning onto the chuck of the machine tool, characterized by comprising means for co-axially causing a workpiece (P) to be machined to be glued by an adhesive onto a supporting base structure (1) and means for subsequently detaching the machined workpiece from the said base structure.

12) Apparatus according to claim 11, in which the means for the adhesion of the workpiece (P) onto the base structure (1) comprise a collet or chuck having a vertical axis and directed upwardly, a manipulator with self-centring chuck which, upon control, positions the base structure co-axially onto said chuck which clamps same, means for positioning on the projection (101) of the structure base a device which upon control distributes spots of adhesive onto said projection of the base structure, while the chuck is rotated about its axis, a manipulator with jaws (5) for co-axially positioning the workpiece onto the projection (101) of the base structure carrying the adhesive spots, a manipulator with a self-centring idle center (6) which is axially pushed onto the workpiece in order to press same and to align it axially onto the base structure, while this latter is preferably caused to rotate by the supporting chuck.

13) Apparatus according to claim 11, characterized by the fact that if the adhesive used is of the type known by the registered trade mark LOCTITE of grade 380, the detachment of the workpieces from the base structure or the reciprocal detachment of the pieces is obtained by means of a mechanical action, for example by impact, by vibrations or thrusts or pressure for the detachment, exerted between the surfaces to be detached.

14) Apparatus according to claim 13, in which the structure base (1) can be provided with apertures or holes for consenting the intervention of extractors for the detachment of the workpiece glued onto the said base structure.

15) Apparatus according to claim 11, characterized by the fact that if the adhesive used is of the type known by the registered trade marl LOCTITE of grade 480, the detachment of the workpieces from the base structure is obtained by subjecting at least the adhesion zone to a heating by induction means, for reaching a temperature of about 150° for a time period of about 20 seconds.
